(19) United States
(12) Patent Application Publication
(10) Pub. No.: US 2019/0143890 A1
(43) Pub. Date: May 16, 2019

(54) OCCUPANT VERIFYING ASSEMBLY

(71) Applicant: Alberta Haislah, Cleveland, OH (US)

(72) Inventor: Alberta Haislah, Cleveland, OH (US)

(21) Appl. No.: 15/813,278

(22) Filed: Nov. 15, 2017

(51) Int. Cl. B60Q 9/00; G08B 21/24

(52) U.S. Cl. CPC B60Q 9/00; G08B 21/24

(57) ABSTRACT

An occupant verifying assembly to remind a driver to check for passengers includes a bus with an interior that has a front console. A housing is positioned on the front console and comprises a front side, a back side and a perimeter wall that is attached to and extends between the front and back sides. A speaker is mounted in the housing. A processor is mounted within the housing and is electrically coupled to the speaker. A memory is electrically coupled to the processor and has an audio file stored thereon to remind a person to verify that the bus is empty. The input sends a vehicle power signal to the processor. The processor sends a signal to the speaker to play the audio file through the speaker when the input sends a vehicle power signal to indicate the bus has been turned off. The input includes a power cord.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to occupant verification devices and more particularly pertains to a new occupant verification device for to remind a bus driver to check for passengers.

### BRIEF SUMMARY OF THE INVENTION

An embodiment of the disclosure meets the needs presented above by generally comprising a bus that has an interior with a front console positioned therein. A housing is positioned on the front console and comprises a front side, a back side and a perimeter wall that is attached to and extends between the front side and the back side. A speaker is mounted in the housing. A processor is mounted within the housing and is electrically coupled to the speaker. A memory is electrically coupled to the processor and has an audio file stored thereon to remind a person to verify that the bus is empty. An input is electrically coupled to the processor wherein the input sends a vehicle power signal to the processor. The processor sends a signal to the speaker to play the audio file through the speaker when the input sends a vehicle power signal to indicate the bus has been turned off. The input further includes a power cord and a power switch. The power switch is mounted on the housing and is electrically coupled to the processor such that the power switch is actuated to turn the processor on or off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front side view of an occupant verifying assembly according to an embodiment of the disclosure.

FIG. 2 is a back view of an embodiment of the disclosure.

FIG. 3 is a front view of an embodiment of the disclosure.

FIG. 4 is a side view of an embodiment of the disclosure.

FIG. 5 is a schematic box diagram of an embodiment of the disclosure.

### DETAILED DESCRIPTION OF THE INVENTION

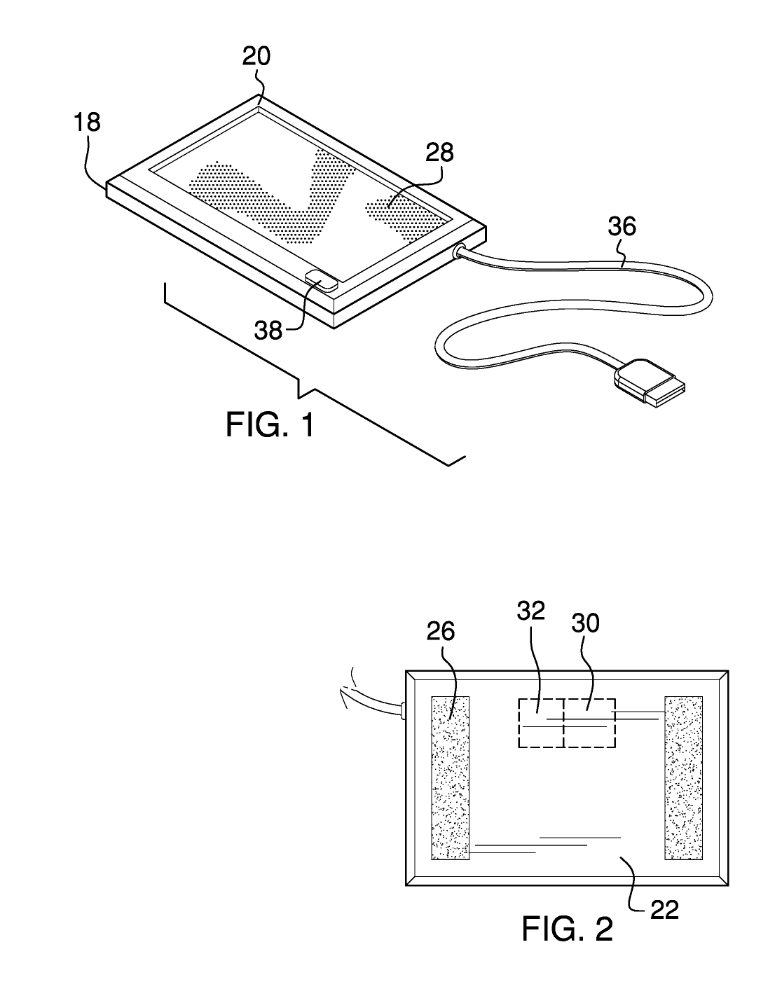

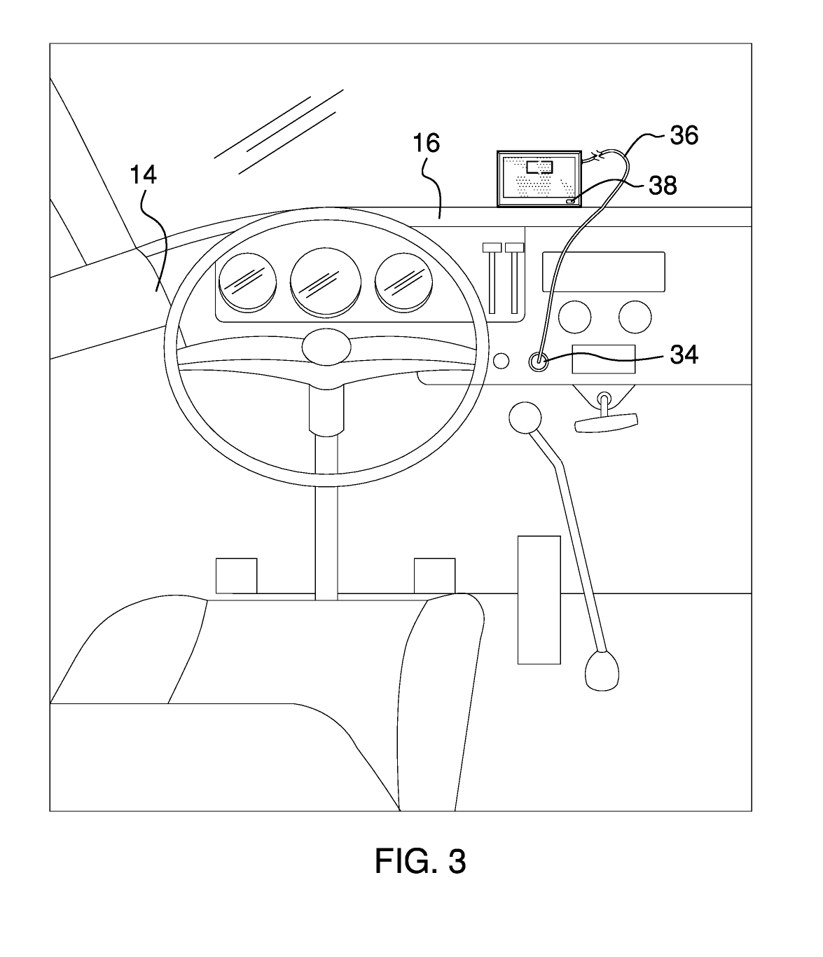

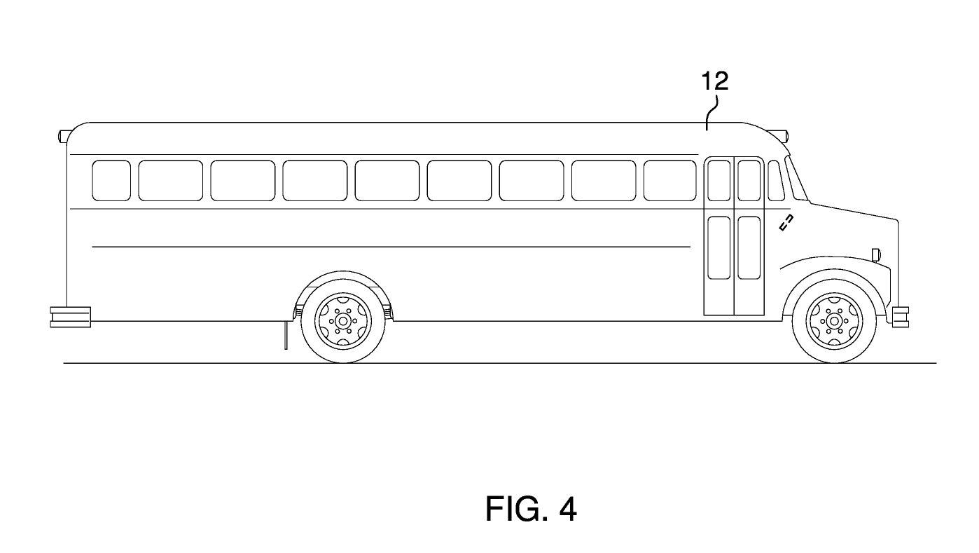

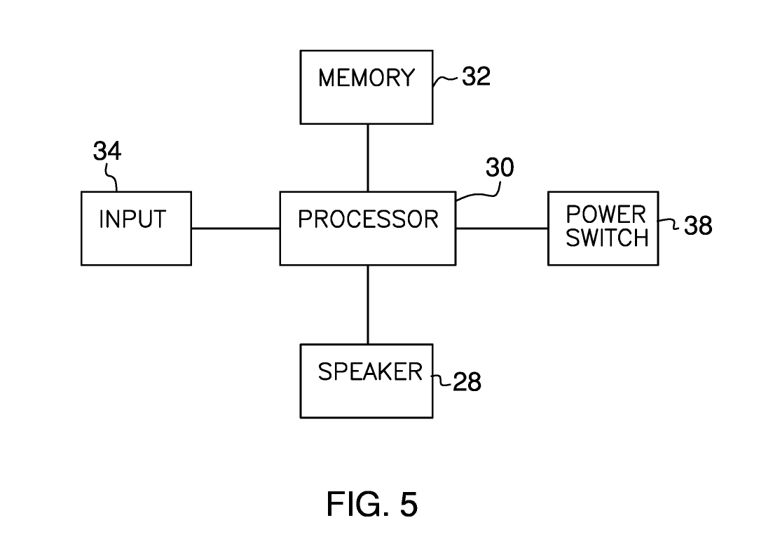

With reference now to the drawings, and in particular to FIGS. 1 through 6 thereof, a new occupant verification device embodying the principles and concepts of an embodiment of the disclosure and generally designated by the reference numeral 10 will be described.

As best illustrated in FIGS. 1 through 6, the occupant verifying assembly 10 generally comprises a bus 12 that has an interior 14 with a front console 16 positioned therein. A housing 18 is included and comprises a front side 20, a back side 22 and a perimeter wall 24 that is attached to and extends between the front side 20 and the back side 22. A mount 26 is attached to the back side 22 and removably attaches the housing 18 to the front console 16.

A speaker 28 is mounted in the housing 18. A processor 30 is mounted within the housing 18 and is electrically coupled to the speaker 28. A memory 32 is electrically coupled to the processor 30 and has an audio file stored thereon to remind a person to verify that the bus 12 has no passengers onboard. An input 34 is electrically coupled to the processor 30 and sends a vehicle power signal to the processor 30. The processor 30 sends a signal to the speaker 28 to play the audio file through the speaker 28 when the input 34 sends a vehicle power signal to indicate the bus 12 has been turned off. The input 34 further includes a power cord 36 that may be electrically coupled to the bus 12. A power switch 38 is mounted on the housing 18 and is electrically coupled to the processor 30. The power switch 38 is actuated to turn the processor 30 on or off.

In use, the assembly 10 is mounted on the front console 16. The power switch 38 is turned on to activate the processor 30. When the bus 12 is turned off the vehicle power signal is sent to the processor 30 wherein the processor 30 sends the signal to the speaker 28 to play the audio file to remind the bus driver to check for passengers onboard the bus 12 before the bus driver exits the bus 12. In this manner, the bus driver will always be reminded to inspect the bus 12 before leaving the bus 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An occupant verification system configured to remind a driver to check for passengers of a bus, said system comprising:
a bus having an interior and including a front console;
a housing comprising a front side, a back side and a perimeter wall being attached to and extending between said front side and said back side, said perimeter wall having elongated top and bottom side sections, said perimeter wall having elongated lateral side sections wherein said housing is shallow between said front side and said back side;
a mount being attached to said back side, said mount being configured to removably attach said housing to said front console;
a speaker being mounted in said housing, said speaker being exposed on said front side of said housing;
a processor being mounted within said housing and being electrically coupled to said speaker;
a memory being electrically coupled to said processor, said memory having an audio file stored thereon reminding a person to verify said bus is empty;
an input being electrically coupled to said processor, said input sending a vehicle power signal to said processor, said processor sending a signal to said speaker to play said audio file through said speaker when said input sends said vehicle power signal indicating said bus has been turned off, said input further including a power cord; and
a power switch being mounted on said front side of said housing and being electrically coupled to said processor, said power switch being actuated to turn said processor on or off.

2. The occupant verification system according to claim 1, further including a mount being attached to said back side, said mount being configured to removably attach said housing to said front console.

3. The occupant verification system according to claim 1, wherein said power cord is electrically coupled to said bus.

4. An occupant verification system configured to remind a driver to check for passengers of a bus, said system comprising:
a bus having an interior and including a front console;
a housing comprising a front side, a back side and a perimeter wall being attached to and extending between said front side and said back side, said perimeter wall having elongated top and bottom side sections, said perimeter wall having elongated lateral side sections wherein said housing is shallow between said front side and said back side;
a mount being attached to said back side, said mount being configured to removably attach said housing to said front console;
a speaker being mounted in said housing, said speaker being exposed on said front side of said housing;
a processor being mounted within said housing and being electrically coupled to said speaker;
a memory being electrically coupled to said processor, said memory having an audio file stored thereon reminding a person to verify said bus is empty;
an input being electrically coupled to said processor, said input sending a vehicle power signal to said processor, said processor sending a signal to said speaker to play said audio file through said speaker when said input sends said vehicle power signal indicating said bus has been turned off, said input further including a power cord, said power cord being electrically coupled to said bus; and
a power switch being mounted on said housing and being electrically coupled to said processor, said power switch being actuated to turn said processor on or off.
